(19) United States
(12) Patent Application Publication
(10) Pub. No.: US 2009/0058860 A1
(43) Pub. Date: Mar. 5, 2009

(54) Method for Transforming Language Into a Visual Form

(75) Inventors: Robert Chin Meng Fong, New South Wales (AU); Billy Nan Choong Chong, New South Wales (AU)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Mor (F) Dynamics Pty Ltd., Sydney (AU)

(21) Appl. No.: 11/887,862

(22) PCT Filed: Apr. 4, 2006
(86) PCT No.: PCT/AU2006/000449

§ 371 Date: May 27, 2008

(30) Foreign Application Priority Data
Apr. 4, 2005 (AU) 2005901632
Jan. 16, 2006 (AU) 2006900203

(51) Int. Cl. G06T 11/00; G06F 17/27

(52) U.S. Cl. 345/467; 704/9

(57) ABSTRACT

A computer assisted design system (100) that includes a computer system (102) and text input device (103) that may be provided with text elements from a keyboard (104). A user may also provide oral input (107) to the text input device (103) or to a voice recognition software with in-built artificial intelligence algorithms (110) which can convert spoken language into text elements. The computer system (102) includes an interaction design heuristic engine (116) that acts to understand and translate text and language into a visual form for display to the end user.

### TECHNICAL FIELD

The present invention relates generally to a method for generating 2- and 3-dimensional visual representations. The method is applied using an electronic device such as a computer, or mobile telephone, for example. The visual representations may be shown on a display for the device, such as a screen. The representations are generated from input provided by a user in the form of language, particularly natural language. The data that is input is either in the form of text, such as words and symbols (eg, punctuation, etc.), or is converted into this textual form if the data is in another form such as speech, images or sign language, for example. Although the invention has a broad range of applications involving computers, including computer imaging and visualization, internet applications, linguistic and artificially intelligent systems, mobile telephones, chat-room internet communication, and computer assisted drawing (CAD) etc.

The present invention also has application in the area of generating visual representations and images of an abstract or imaginative nature, for aesthetic purposes. For example, visually interesting images can be generated to appear on the display screens of mobile telephones, computer screens, PDAs, or portable audio-visual players, for example. The input data that generates the visual representations can be text entered by a user, such as the content of an SMS message created or received by a mobile phone user, or even the content of a conversation on a mobile telephone or VOIP application on a computer, or lyrics of a song playing on the device, if a voice recognition application is engaged to convert the conversation into text-type input, for instance. The invention analyses the meaning of the text to create visual representations. The visual representations created can therefore be unique and distinctive, and depending on the input can range from abstract images and designs to actual real-world things, or combinations of these. A process utilising the meaning or some attribute of the text used as the input generates the visual representations, and the representations are modified according to additional text that is input by a user.

### BACKGROUND ART

Computer assisted drawing (“CAD”) programs are currently used to automate the drafting process in the creation of drawings, designs, prototype, blueprints and the like representations, usually in the architectural, engineering and interior design industries, for example. But a user of these CAD design programs will do the actual creation of a design entirely within the user's own imagination. The resulting representations are constructed using computer software that inserts lines, arcs, circles and other graphical elements at locations determined by the designer according to his or her wishes. Some existing CAD software packages allow the use of predetermined representations of standard design objects such as to represent walls, floors, rooms, windows, doors etc. which consist of a predetermined assembly of simpler design elements of lines, arcs, circles, etc., that can be selected by the user and then placed within the representation of a design drawn using the CAD package.

It is also possible for a user to retrieve these drawing elements to use within the CAD process, by using input in the form of a word that describes a particular design object, and having a predetermined representation of an object appear that corresponds to the meaning of the word used. The word can be input by typing text using a keyboard, or from speech with the intermediation of voice and speech recognition software, for example. For instance, by inputting the word “chair”, a user is able to select a representation of a chair, and position that representation within the CAD workspace within a particular design representation.

In one known CAD system, a user can be prompted with a series of questions in order to elicit successive drawing elements in a design brief. For instance, in a response to a series of questions and responses, a user may define the nature of a building, the dimensions of each floor, the number of floors, the overall dimensions of the building, and so on. A visual representation of a building having these specified dimensions and appearance is then displayed to a user for subsequent manipulation. These CAD systems are useful for automating the common tasks carried out by a designer.

However, such systems merely rely upon a system of matching a word with the corresponding design element that this word represents, normally by matching the two from a predetermined selection provided in a database, which is part of the CAD software package. Alternatively, a CAD package can utilise a shorthand glyph or icon instead of a word to represent a design element so as to operate in a corresponding manner. Essentially, the word or icon merely functions as a key to identify the design element in a database and subsequently allowing the selected element to be manipulated further.

The resulting design arising from the CAD software package is entirely as the user conceives and creates it. Existing CAD packages in fact are unable to contribute anything to the creative aspects of the design process. The CAD software functions merely as a technological interface between the designer and the visual representation of a design that the designer conceives and constructs using the software merely as a tool. This can often diminish the creative capacity of the designer.

The CAD software normally functions to create representations of concrete artificial and natural objects rather than abstract patterns and shapes. Other software packages for painting and drawing abstract designs are available, but that software generally suffers the same limitations as with the CAD software, because the user must work with design elements such as lines and areas selected from a pallet of predetermined options.

Computer software exists that can generate an abstract image. For example, an abstract image can be generated when music is being played on a computer; the appearance of the image being based on the music being played. But such images change their appearance based only on the data directly available, generally the volume and frequencies of the sound. The images generated by such means do not change in appearance according to the meaning of the lyrics of the song being played. It would be useful to create abstract images that change according to a natural language data source, in a manner that depends on the meanings of the natural language.

Also, computer software exists that transliterates natural language input in the form of text or spoken words into sign language for hearing-impaired persons. The sign language is generally displayed on a computer screen in the form of a torso, arms, head and face of a stylised or representational person. This image of a person is animated to display the sign language in a similar manner to how a real person would do so, by making facial, hand and arm gestures. But this system is merely a direct transliteration from one language, eg, English into another, eg American Sign Language. The software does not analyse the meaning of the words or phrases being translated, but only displays the equivalent word in sign language style. The software is incapable of creating any new sign language from any data being input.

These previous software applications do not interpret the meaning of the textual input, but merely match a word to an image or image element. These applications have difficulty in distinguishing homonyms; words that have different meanings but sound or are spelt alike, such as “bank” meaning either a financial institution or the side of a river. An approach that considers the underlying meaning would allow homonyms to be resolved without requiring additional user input to resolve the ambiguity.

International Patent Applications WO 2005/074588 and WO2005/074596 by Yahoo! Inc disclose the generation of emoticons or avatars from text, in the context of sending and receiving messages using an “Instant Messenger” type software application. The emoticons are images of characters or faces that visually change according to the content of the text messages that are sent and received, and are meant to match the mood of the users. For example a message “I am . . . sad” should dynamically generate an image of a sad character. However, the described system merely carries out pattern matching of the text to create appropriate images. Predetermined words and phrases trigger an image that matches the emotional state of the corresponding words or phrases. This system is likely to be easily fooled, and it also requires all possible text patterns to be created, so as to obtain valid results. The phrases “I am sad”, “I am not sad”, “I'm sad”, “Im sad”, “I am unhappy”, as just some examples, all have to be resolved correctly. These examples show potential pitfalls of this approach, such as the need to create large numbers of pattern matching templates, the need to handle synonyms and homonyms, and the need to manage abbreviations and punctuation, as just some instances.

In practice, the pattern matching approach gives poor results if the images to be generated need to be an accurate representation of the meaning of the language that is input. A much better approach would be to analyse the meaning of the text, instead of merely looking for specific patterns of words within the text. This can be done by analysing the major part or preferably the whole of the text, so that its correct meaning can be determined. The analysis of the language used can utilise linguistic principles, to then preferably carry out a best fit between the input text and the images it represents.

In the past, attempts have not been very successful to process language type input using computers or similar devices in order to obtain transformed output that requires the computer to apply some sort of creativity in the process. This is possibly due to the inherent complexity involved in getting the computer to understand the language being input, which is multiplied many times when attempting to convert this to a form that preserves the meaning of the language. For example, while computer assisted language translation software is available for translating from one language to another, these do not work very effectively, and normally require human assistance to produce accurate results that match in input text, because of the creativity required to generate natural language.

However, it has now been realised that it is a more achievable task to generate output that preserves the meaning of the input language, not in the form of more language or other text, but in the form of images or other visual representations. While this may seem surprising, it has now been found that this approach has unexpected advantages. It turns out to give better results. It more easily allows for the integration of feedback from the user into the creation process, especially when the process starts to give erroneous results. If the image that is generated is faulty, the user can readily perceive where the error lies, and respond with corrections. It is easier to determine if the problems arose from the language data that was input by the user, or by the process running on the computer that analysed it. Humans are good at comprehending visual information. In contrast, they have trouble interpreting faulty language if this is all that the computer creates. Therefore converting language into images should be able to utilise the capabilities of computers and software more effectively, to create results useful in a wide variety of commercially applications.

It would be desirable to provide a computer assisted software tool that can assist a user and/or designer in the creative process rather than merely being a tool to generate a visual representation that only matches what is already conceived by the designer, by using the natural language that a user inputs to create images that have a relationship to the meaning of that language. It would also be desirable to provide a software tool and process than can generate abstract images and esoteric visual representations that have a direct relationship with the natural language that a user can input, by creating images that relate to the meanings of the language, and as such ideally generate expressive, emotional, accurate, individual, or unique representations, for instance. It would also be desirable to provide a process for converting language input by a user into visual representations that relate in some way to the meaning of the language, which allows the user to interact with the process by providing feedback in the form of further language input, and to modify the visual representations to effectively give a result acceptable to a user as an useful representation of the language provided to the process.

It would also be desirable to provide a computer assisted design process and tool that ameliorates or overcomes one or more known disadvantages of existing computerised design and image creation techniques or that may provide a useful alternative to them.

### DISCLOSURE OF THE INVENTION

These and other advantages are met with the present invention, which in one broad form concerns a method for transforming data utilising an electronic device, from a substantially natural language text form into a visual form that is capable of being shown on a display unit of an electronic device as a 2- or 3-dimensional visual representation; comprising the steps of; (a) a user inputting the data into the device; and if not already in the text form, having the device convert it into the text form; (b) processing the text form in the device to transform it into the visual form; (c) a user inputting more of the data into the device, and if necessary converting it into more of the text form; (d) processing the text form from step (c) in the device to modify the visual form to an adapted visual form; (e) if desired, repeating steps (c) and (d) one or more times; characterised in that the processing is carried out by dynamically analysing the text form, determining at least one meaning for at least a substantial portion of the text form, determining at least one visual representation that corresponds with the meaning, and creating or modifying a visual form to accord with the visual representation.

Preferably, the text form is one or more words in natural language. Also, if the data in steps (a) or (c) is initially in the form of spoken language, then it may be transformed using voice recognition techniques into a text form. Preferably also, the meaning is determined by applying semantic, morphological and/or syntactical principles to the text form.

Optionally, wherein in step (b) or (d), if the meaning of the text form cannot be sufficiently determined in order to determine a visual form for its transformation, then a further step may be conducted, of preparing and requesting and optionally receiving further input from the user, one or more times, until the meaning can be sufficiently determined. In this situation, the preparing and requesting and then optionally receiving further information may comprise displaying a question in natural language, to the user, and then allowing the user the option of responding to the question, by inputting additional data into the device, which is further processed in step (b) or (d).

It is preferred that the meaning may be determined by the steps of: (i) separating the text form into a plurality of text elements, each consisting of individual words, or segments of text comprising multiple words; and (ii) tagging each text element according to its semantic, morphological, and/or syntactical purpose to provide a plurality of sets of tagged text elements; and (iii) whereby the tagging permits at least some understanding of the meaning of the text form. In this situation, it may be preferred that the tagging of each text element may be for the purpose of any one or more of:— determining a text element that represents a thing and then displaying a visual representation of the thing, determining a text element that represent an action and then displaying a representation that visually embodies or utilises the action, determining a text element that represents an attribute of the thing or the action and then displaying a visual representation that visually embodies or utilises the attribute. As another option, the attribute of the thing or action may be an emotional attribute. In this situation, the emotional attributes can be any one or more of the following classes: anger, contentment, discontent, envy, excitement, fear, joy, loneliness, love, optimism, peacefulness, romantic love, sadness, shame, surprise, worry.

As another preferred option, the text form may be analysed by mapping it to one from a selection of predetermined templates. Optionally, the text element may be determined to comprise instructions for manipulating the appearance of the visual form. If this is so, then the instructions may allow for the creation, deletion, movement, or interrelation of the visual form, or of components of the visual form.

It is preferred that the visual representation may be determined by analysing the visual characteristics of a plurality of visual representations, wherein each of the characteristics have one or more representative meanings allocated to them, and carrying out a best fit determination to select one or more visual representations that most closely match the meaning determined from the text form. As another option, a basic visual form can be selected that is subsequently manipulated in steps (c), (d) and (e). In this situation, the basic visual form can be chosen from a group of visual forms by the device obtaining input data from a user one or more times to limit the visual forms until one form is selected. Optionally, the basic visual form may be obtained as input from a user as a visual form, and subsequently manipulated in steps (c), (d) and (e).It is preferred that the visual characteristics comprise features of descriptive appearance, including the size, shape, location, configuration, colours, 3-dimensional orientation, background, appearance of movement, of the visual representation. The visual form optionally may be created or adapted by applying domain knowledge about the visual form to the visual representation, and adapting the visual form in accordance with the domain knowledge.

As another preferred feature, the device may store the history of each user's utilisation of the method, and utilises this history in one or more steps. It is preferred that the visual form may change to the adapted visual form by morphing between the forms. As another option, in step (b) or (d), a user may additionally make a choice to create either a visual form representing a thing that exists in the world or a visual form representing an abstract or non-representative image that does not exist in the real world.

The invention also concerns an electronic device for carrying out the above method, and interacting with a user, which includes:—(1) one or more input means to accepting data input in the form of text, or in some form that is capable of being converted into a text form, (2) a natural language processor sub-system/engine capable of analysing natural language and determining the meaning of one or more text elements that comprise the natural language, (3) a 2-D or 3-D modelling and rendering processor sub-system/engine that creates a visual representation associated with the text elements of (2), and (4) one or more output means for displaying a visual representation, or for holding or transferring data that is capable of being converted into a visual representation, and (5) a user interface.

The device may optionally further include: (7) a heuristic processor sub-system/engine that holds the history of a user's interaction with the natural language processor, and utilises the history in determining the meaning in (2). The device may optionally further include: (8) a object or pattern recognition processor sub-system/engine as part of (7) that assists with the mapping of a text element to a visual representation. The object or pattern recognition processor sub-system/engine may optionally update the domain knowledge for the visual representations available in the system. The device may optionally further include: (9) a morphing processor sub-system/engine as part of (3) that renders and morphs the visual representation during transitions from one visual representation to a modified visual representation. The device may preferably be a computer, a PDA, or a mobile telephone. The invention also concerns a program for operating an electronic device that performs the method described above.

The following description refers to in more detail to the various features of the computer assisted design method and systems of the present invention. To facilitate an understanding of the invention, reference is made in the description to the accompanying drawings where the invention is illustrated in a preferred embodiment. It is understood however that the invention is not limited to the preferred embodiment as illustrated in these drawings.

### BRIEF DESCRIPTION OF DRAWINGS

The invention is now discussed with reference to drawings, where:

FIG. 1 is a schematic diagram of a preferred embodiment of the method of the present invention;

FIG. 2 is a schematic diagram of the main components of the heuristic engine portion of the invention;

FIG. 3 is a schematic diagram of a computer assisted design system in accordance with one embodiment of the present invention;

FIG. 4 is a flow chart illustrating the operation of an interpretive engine forming part of the computer assisted design system of FIG. 3;

FIG. 5 is a timing diagram illustrating the interaction of a user with the computer assisted design system of FIG. 3;

FIG. 6 is a sample of codified text that in one embodiment of the invention can be used to generate visual representations;

FIG. 7 is an example of a visual representation arising from the text of FIG. 6;

FIG. 8 is a schematic block diagram indicating the components that are contained within the Heuristic Engine 116 contained within the computer system 102 also known as the interpretive cognitive linguistic algorithm engine;

FIG. 9 is a schematic flow chart illustrating the operation of the Natural Language Parser to handle context and content in language;

FIG. 10 is a schematic flow chart illustrating the text analysis process;

FIG. 11 is a schematic flow chart illustrating the operation of the 3D Graphics engine contained within the heuristic engine of FIG. 3;

FIGS. 12A, 12B and 12C show an object, namely a camp chair being generated;

FIGS. 13A, 13B and 13C are representations arising from emotional context analysis;

### BEST MODES FOR CARRYING OUT THE INVENTION

Generally, the invention concerns a method for understanding, parsing and transforming data from a substantially natural language text form, or from text created from a spoken input form, into a visual form that is capable of being displayed on a display unit as a 2- or 3-dimensional representation. The method utilises a electronic device, such as a computer, mobile telephone, personal digital assistant (PDA) device, or the like.

Ideally, the text form is one or more words and syntax contained in a human language. The term “text form” may normally be considered as comprising one or more words, especially from natural language. But it includes words in languages that have characters that directly represent meanings of things, such as in the Chinese and Japanese languages for example, rather than a generally phonetic equivalent to spoken word, such as with the English language. The important aspect of the textual element is that there should be some meaning extractable from it. For instance, strings of noun phrases, adjectival phrases, etc, which form a logical and understandable context in language are a text form, while a random string of characters that are codified within a computer system are not. Therefore, individual Chinese characters or Japanese kanji may constitute textual elements, even if they do not appear on their own to form words, but are only normally used with one or more other characters, or Japanese kana characters, to form compound words, for example. American Sign Language using gestures, or Braille, or Morse code, and the like can also constitute a text form, for similar reasons.

The text may be input by any suitable means, such as using a keyboard, numeric keypad such as that normally provided on a mobile telephone handset, hand writing tablet, or optical character recognition of previously printed materials, as just some examples. A combination of different text input methods may also be used.

If the input data is not already in a text form, it is converted to such a form. The data may initially be spoken language, for example, and if so, it is converted into text. This may be conducted by any suitable means, such as using voice recognition software, for example, like “Dragon™ Dictate” for instance. Other input forms may also be utilised, such as gestures, or haptic devices that convert touch and especially hand and finger gestures such as joysticks or more sophisticated device, and these are also allow the data that is input to be converted to text by a suitable means. A combination of different input forms, including text, voice, gesture and the like, may also be used. Voice, and voice recognition software is especially appropriate with mobile telephones, optionally in combination with text entry using the mobile telephones numeric key pad.

The visual form that results may be in any form that can concurrently, or subsequently, or potentially, be displayed on a screen of a computer or other electronic device. This includes showing the representation directly on a screen, or sending it to a printer, or storing the representation in the form of data in any suitable digital format on the computer or on other computer media such as mobile phones and Personal Digital Assistants (PDAs), etc, which can then independently be converted or displayed as a representation on that or another computer, or by using other external devices or peripheral equipment or software.

The representation may be 2- or 3-dimensional in appearance. This means that with 3-dimensional representations, it normally displays as a 2-dimensional image but with perspective and other visual aspects so that to a human eye, it appears to represent a 3-dimensional object or image. Possibly, the 3-dimensional representation may alternatively be in a format that it can be used to directly create a 3-dimensional model or object, using suitable machinery, such as CADCAM or rapid prototyping technologies.

The representations created by the method may be of recognizable objects such as man-made and artificial objects like chairs, tables, rooms etc, for example, or natural objects like landscape, trees, birds etc, for example, or of characters such as people, cartoons, faces, animals, insects, etc, for example. The representations may also be of abstract shapes, patterns, colours and the like, to represent non-tangible elements such as mood, emotion, concept, idea, etc. The representations may be of a combination of recognisable objects and abstract images. The representations may be static, or may include or consist of animated or changing images or portions. This may result in representations that appear to change over time, either randomly to appear aesthetically attractive or interesting to an observer, or non-randomly so as to represent animated or movie-like visual representations, or it may be a combination or mixture of these static and dynamic elements.

The method generally involves inputting the data into the device; and if necessary, converting it into the textual form. The text form is analysed, and the meaning of the text form is determined for a substantial portion of the text elements present. The text elements are ideally words, but include punctuation as well, which has an effect on the meaning. Preferably the entire text form is analysed for meaning. In this case, the system analyses all the text that is input. This approach has clear advantages over the mere matching of a few keywords, which constitute only a small portion of the available text that is input.

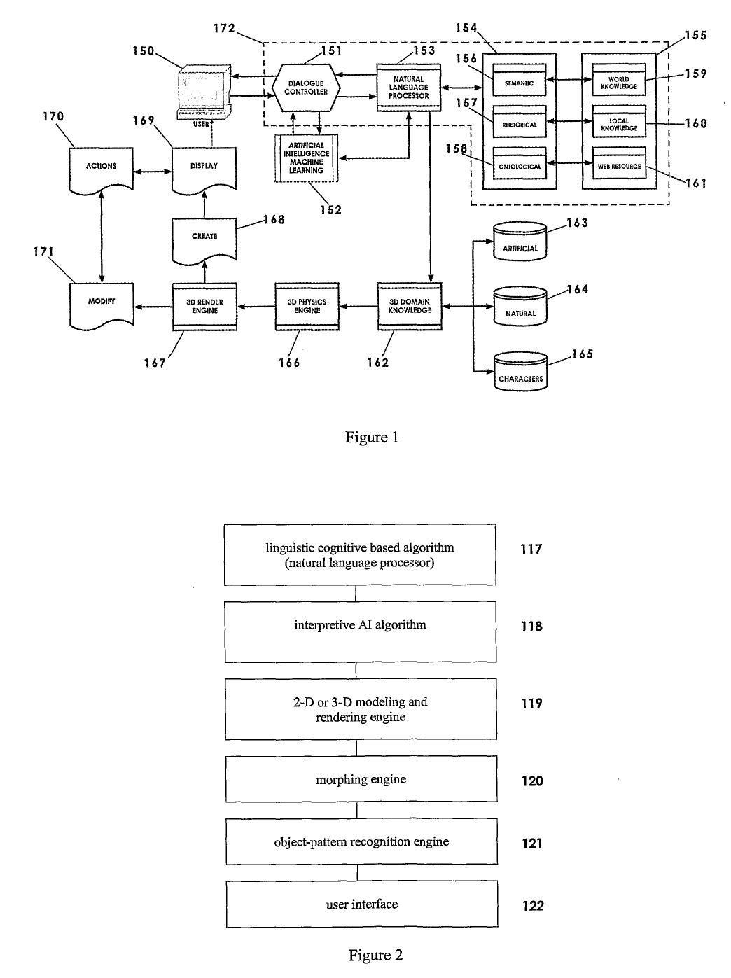

One approach is shown in FIG. 1. The user (15) inputs language data into a computer. The text so entered initially passes to the natural language processor section (172) or the the main processing unit (153) where its meaning is derived, or and attempt to do this is made. If the natural language processor is unable to resolve the meaning of the text sufficiently, then the dialogue controller (151) may provide the user (150) with some questions in order to attempt to resolve the meaning. Each reply from the user is passed to the natural language processor (153), until success is achieved. The dialogue controller (151) interacts with the artificial intelligence machine learning module (152) which keeps a history of the user's past interaction with the system. The information is also used to resolve problems with deriving the meaning for the user's text input.

The natural language processor (153) contains the sub-components (154) comprising the semantics unit (156), rhetorical unit (157) and the ontological unit (158). The semantics unit (156) analyses the syntax and morphology of the text. The rhetorical units (157) analyses rhetorical structures, such as those dealing with explanation and elaboration, such as greetings, and the like, in order to construct natural dialog with users, for instance. The ontological unit (158) handles tagging. These sub-components (154) interact with a concept store (155) that hold information about the real world. The semantic module (256) interacts with a concepts store (155) that holds information about the real world, which holds information about the wider world (159), local environment (160), and with wider knowledge that is held on the internet (161), for example. These components act together to interpret the text provided by the user to derive its meaning.

Once the meaning has been derived, the natural language processor (153) passes this information to the components of the system that create and maintain the visual representations associated with that derived meaning. The 3-D domain knowledge unit (162) holds information about the images and models that are associated with the meaning of the text, which are then rendered into a visual representation by the 3-D Physics engine (166) that creates a meaningful visual representation consistent with the real world, or the desires of the user. The images can draw on stored images and models such as those of artificial or manmade items (163), natural objects and scenery (164) or people or characters (165), for example. The 3-D render engine (167) creates the actual visual representation of a screen. The visual representations are created (168) and displayed (167) to the user, or else the user can input text to modify the images (171) by specifying actions (170) to manipulate the image to generate an adapted visual representation.

FIG. 3 generally shows an embodiment of the invention involving a computer assisted design system (100), that includes a computer system (102) and text input device (103).

The text input device (103) may be provided with text elements from a keyboard (104), or alternatively provided with text from other sources such as HTML pages, (105) or other text based applications (106), such as SMS messages on a mobile telephone, or instance. A user may also provide oral input (107) via a microphone (108) such as one on a mobile telephone, in order that voice input us provided to either the text input device (103) preferably using a voice recognition software application with in-built Artificial Intelligence algorithms (110) that is part of the computer system (102), which can then convert the spoken language into text elements.

A predefined basic form representing an exemplary form such as a cup, table, door, chair etc, or an abstract image or combination of these, or any other initial basic exemplary form, may be provided in a text form, but may also be provided to the computer system (102) by means of a drawing tablet (111) or image scanning device (112), resulting in the generation of an electronic representation of the form at a translation device (113), that assists in the translation and transformation process. 2-dimensional or 3-dimensional data characterizing the scanned or drawn visual form is extracted at the data extraction device (114), before being provided to a storage device (115) forming part of the computer system (102). The storage device (115) may contain a library of predefined basic forms that are to be subsequently modified by the properties of and relationships between textual elements forming part of a textual input to the computer system (102) and by subsequent user manipulation.

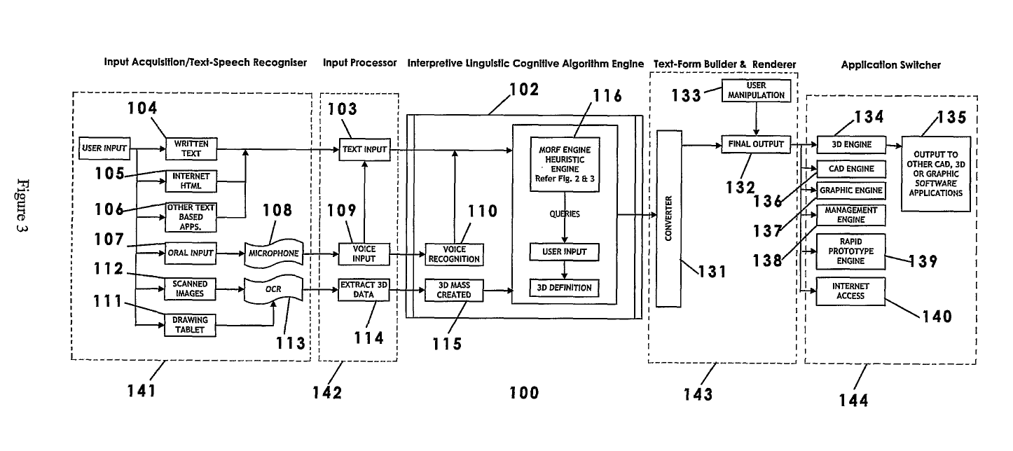

The computer system (102) importantly includes an interaction design heuristic engine (116) that assists and enhances the design process. The design heuristic engine (116), through a process of analysis, interpretation, querying and feedback acts to understand and translate text and language into a visual form for display to an end user. The engine enables the understanding, interpretation and translation of language-based user input into a recognisable 2D or 3D output. The engine (116) includes a number of principal components, which are shown in FIG. 2. These involve, (i) a linguistic cognitive algorithm (117) or Natural Language Processor (“NP”) that understands grammar, syntax, content, concept, nuance, double-meanings etc. in language; (ii) an interpretive artificially intelligent algorithm (118) (or heuristic engine) in machine learning that assists that NLP in recalling, capturing and refining keywords and their definitions and sending back queries to the user to obtain additional information in the form of feedback—this algorithm is able to solve queries in real time; (iii) a 2-D or 3-D modelling and rendering engine (119) that has the capacity to take translations and identification of the interpretive algorithm to develop fall 2D or 3D models of the described language—for example, a user defining the properties and concepts of a chair is able to generate a factorial of possibilities of chair designs and forms, based on the interpretive mechanisms of the algorithm; (iv) preferably, a morphing engine (120) as part of the 2-D and 3-D modelling and rendering engine that is able to handle fluid dynamics, particle systems, rigid and non-rigid dynamics in order to achieve real-time rendering techniques for visualizing content in language; (v) preferably, a Object or Pattern Recognition engine (121) that provides computer vision technology in assisting the visualization process by being able to automatically identify, recognize, classify, explode, tag and parse 2-D or 3-D image-model data as part of self-detecting and updating mechanisms for the 3-D engine; and (vi) a graphic user interface (122) that allows users to manipulate, develop and refine the design outcomes in real time.

By “engine”, “device”, or “unit” is meant a software and/or hardware module which takes some input data, processes that data to achieve the desired result, and passes out some transformed output data, which can then be further processed by the same module, or another module or handled in some other manner, such as by displaying the resulting data on a computer screen, for instance. These can be software code, or a single silicon chip that performs this operation, for instance. These can be actual physical items like devices, electronics or chips, or virtual ones like software or instructions that operate in these devices.

The linguistic cognitive based algorithm (117), interpretive algorithm (118), 3-D modelling and rendering engine (119), morphing engine (120), object-pattern recognition engine (121) and user interface (122) are referenced in FIG. 3.

An example of what may happen is as follows. A user enters “I would like to see a comfortable chair” as input, which is passed into the heuristic engine (116). These text elements are then analysed in the Natural Language Processor (117) and the meaning of this wording determined, if possible, as discussed in more detail below. If the system can determine a meaning of this language, it passes this information to the rendering engine (119), but often, the system will require further input before it can do this. In this case, the interpretative artificially intelligent algorithm (118) takes the information, that has been partially or ambiguously interpreted, and creates one or more queries to the user, normally as questions on the screen, that the user is expected to answer. The interpretative algorithm (118) also stores the results of past interactions with the user, which it uses to analyse the information, and in this manner “learns” something about the user's manner of language expression that it can use to determine the meaning of the textual input.

The visual form is modified by the meaning or aspect gleaned from the text form, according to the semantic, morphological, or syntactical elements of the text. Semantics is the study of meaning and changes of meaning. Morphology is the branch of linguistics that studies the rules by which words are linked to other words, such as “dog” with “dogs” which is a rule to describing the formation of the plural of some words. Words are the smallest units of syntax. In simple terms, semantics pertains to what something means, while syntax pertains to the formal structure or patterns in which something is expressed.

Once the meaning is sufficiently understood by the system, the data is passed to the rendering engine (119), which renders a representation of a comfortable chair on the computer screen. For example, it displays a chair, but one that has padding, having learnt that the word “comfortable” is being used to mean chairs with this attribute. The word “like” indicates that the system should add this representation to the display, just as conversely “hate” would delete the representation. The language used is able to control the representations as well as create and modify them.

The user can continue to enter natural language to modify the chair being displayed, and when this results in the chair changing its shape or design, the morphing engine (120) smoothly transforms the representation from the first to the second version. This step is optional; it is also possible to abruptly alter the representation, but users often prefer to see the design change gradually and aesthetically.

To further assist with the representation's appearance, then the object pattern recognition engine (121) can optionally be utilised. This engine can access a wider selection of object representations, for example by obtaining images of objects from the internet, or from an image that the user scans or sketches into the system. It then matches the new object with images already on the system, matching the patterns, and enabling the new object to be handled in the 2- and 3-D rendering process. For instance, the user may be designing a chair, and wants an “armchair”. Perhaps the system has other types of chairs for display, but no armchairs. The object pattern recognition engine can be utilised to find a representation from the internet that the user recognises as an armchair, or scan such an image into the system, and upon selection, the engine also matches this version of a chair to its existing models; identifying its back, legs, seat, arms etc. The object pattern recognition engine (121) can also be utilised to automatically update the domain knowledge held on the system about the visual representations.

Finally, there is a user interface (122) which allows the user to control the process, and save the output, print it, and the like, management tasks, as well as providing an alternative to the text activated processes, in the form of menu item, for example, if this is desired. Each user of the computer system should ideally be uniquely identified, so that the artificial intelligence interpretive algorithm (118) can store information about each user.

It should also be noted that this system can work where there is no specific object referred to in the language input. For example the language input of “Hello, I feel happy today”, could trigger abstract representations, that suggest to the user the idea of “commencement” eg, a pattern that grows from left to right, (from the meaning of “hello”) and “joy” eg, bright colours, (from the meaning of “happy”). The same input may alternatively produce a realistic image like a smiling face, for example, instead.

The user can, if desired, render natural language input to generate an abstract representation, or as a fantastical image mixed with realistic representations, or combinations of abstract or unreal images, with realistic ones. For example, a user may create a representation of a real object like a chair, and then create an abstract background picture, to go with it.

Ideally, the user has the option of selecting whether the image should be representational of real-world objects, such as a chair or scenery, or whether the visual representation to be created is primarily abstract or artistic. For example the system's user interface may have a selection option for choosing between the two. This choice may be made with each iteration of the design development procedure, so that a chair can be created during the first dozen or so iterations, and a non-representational background artistic and abstract representation may be added afterwards.

The natural language forming the input can be used to assist with the creation of a particular type of visual representation. Language dealing with emotions, personal thoughts (eg “I feel happy today”), is especially adapted to create abstract images, whereas descriptive and objective language is adapted for creating objects, (eg “I would like to see a comfortable armchair”). Preferably, the user selects one mode or the other. Otherwise the system may request further clarification and language input from the user, particularly for it to create an object if this mode is selected, but the meaning of the language is insufficient for the system to generate an object.

Returning to the system in FIG. 3, the converter (131) converts the output of the design heuristic engine (116) into a final visual display (134). Following user manipulation (135) of the final output, the resultant design may be provided to any one or more of a 3-D Engine (134), CAD engine (136), graphic engine (137), management engine (138), rapid prototype engine (139) or simply transmitted to a remote device via internet or other network access (140), or handled by another means.

The computer assisted design system (100), can be conveniently divided into subunits, as shown in FIG. 3, where the Input acquisition/Text speech recogniser unit (141) passes data to the Input processor unit (142) which in turn passes information to the Interpretive linguistic cognitive algorithm engine (102), which then passes data to the text-form builder and renderer unit (143), which then passes data to the Application switcher unit (144).

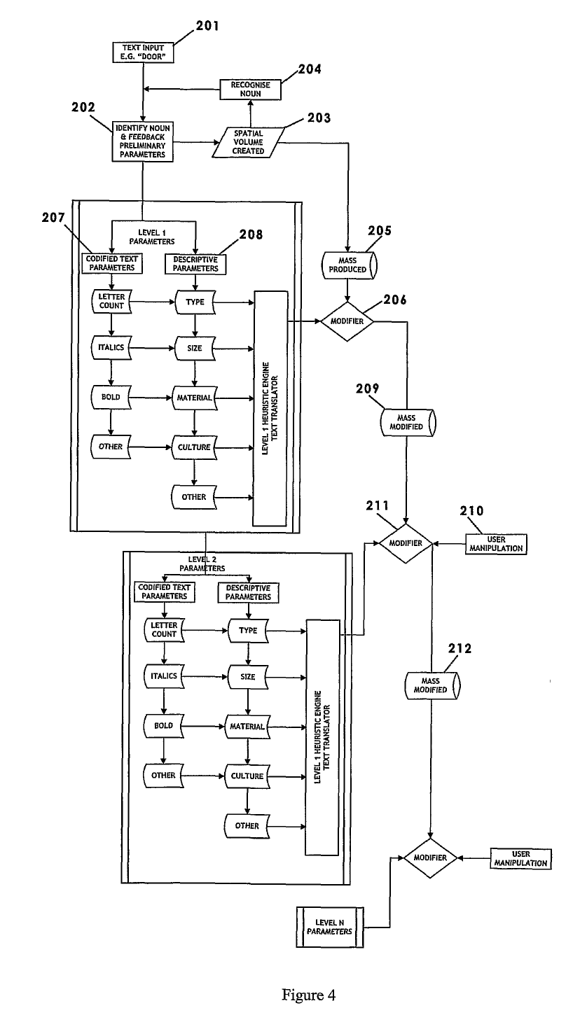

FIG. 4 shows the general flow of the process for generating a visual representation. At the start of the process, it is usual to define the generic or general item from which the design grows, such as a generic “door” or “chair” for example, which becomes the “basic visual form”. If no basic form is selected, then the process can be used to generate an abstract representation instead, or else it can request more information from the user, in order to proceed.

As can be seen in FIG. 4, the design processes using the computer assisted design system (100) as shown in FIG. 3, generally commences with determining the basic visual form (203). As one option, the basic visual form may be chosen from a group of visual forms by having the computer obtain input data from a user one or more times to eventually reduce the visual forms in the selection group until just one form is selected. This is made possible by a dialogue controller as part of the Natural Language Parser (117) and interpretive algorithm (118) to enable query/feedback dialogue between a user and the system, which is discussed in more detail below. Alternatively, the basic visual form may be input by the user as a visual form, either by creating it in this manner, or by selecting it manually from an external source and inputting it as is. In this case, it is preferable in a format that can be manipulated subsequently by the process of the invention such as in a CAD format.

As mentioned, choosing the basic visual form from a group may be done in a number of ways. Such as having the computer ask the user a number of questions (via the dialogue controller), and processing the answers input by the user until a single desired form results. The basic visual form helps identify the domain for the visual representations, and can speed up the whole process. It is not necessary to do this in all circumstances. Some applications of the invention can commence with this already determined. For example, the basic visual form may be already be chosen to be an emoticon “face”, in a chat room application, and so a further selection may not be necessary. Or else, one from a number of different versions of the face may be selected by a user as the basic visual form, in this situation.

Alternatively, the user may input text, and the computer may analyse this and locate a basic textual form from some of the text elements, using rules for doing so. The result is a basic visual form selected from a group, all of which may be kept on the system in a database of such forms, and all in a suitable format, such as a CAD format, for later further manipulation.

One example of selecting a basic visual form is shown in FIG. 4, where some natural language is entered by a user (201), in the form of textual elements such as, “I would like to see a door”. The meaning of this text is analysed according to some heuristic rules and principles at step (202) in FIG. 4. Various approaches for analysing the text exist. As a simple approach, the basic meaning may be determined from a significant portion of text input, with some user assistance. In a more advanced approach, the program may analyse the grammar, syntax, context, concept and/or content in most or all of the textual elements that were input and extract an understanding of that text so that the program understands the objective of the noun phrases, etc, contained within the text and compares this understanding with a parts-database library of visual forms that match the keyed-in description of the text which can then be assembled on screen to depict the user's description of a particular object or form, using best fit principles.

In FIG. 4, at step (202), the design heuristic engine analyses the input text and determines from a library (115) of stored visual forms (or spatial volumes with specific domain knowledge) at step (203), whether a predefined basic visual form exists for the input text. If, at step (204), the text input has been recognized as containing some kind of objective embedded within a noun phrase and its sub-derivative linguistic components for which such a pre-defined basic form exists, the next stage of the design-visualisation process is followed.

If no predefined basic form exists, the user is able to use the drawing tablet to usually represent the input text provided by the user. Alternatively the user is able to scan an existing image or provide rata representing the visual form of the basic predefined form by other suitable means to the computer system (102). As a further alternative, a further set of questions may be posed to the user, to extract some input data that may be used as described above to visualise a suitable final form. As yet another alternative, the system may generate an abstract representation if unable to identify a real-world basic visual form, or if the user desires this.

At step (205), the initial predefined basic form is created that corresponds to the text originally input by the user at step (201). This form is subsequently modified at step (206) and in later steps (211). This is done by matching at least one aspect of the visual form, to at least one meaning or aspect of the linguistic description entered by a user. A variety of approaches for doing this may be employed.

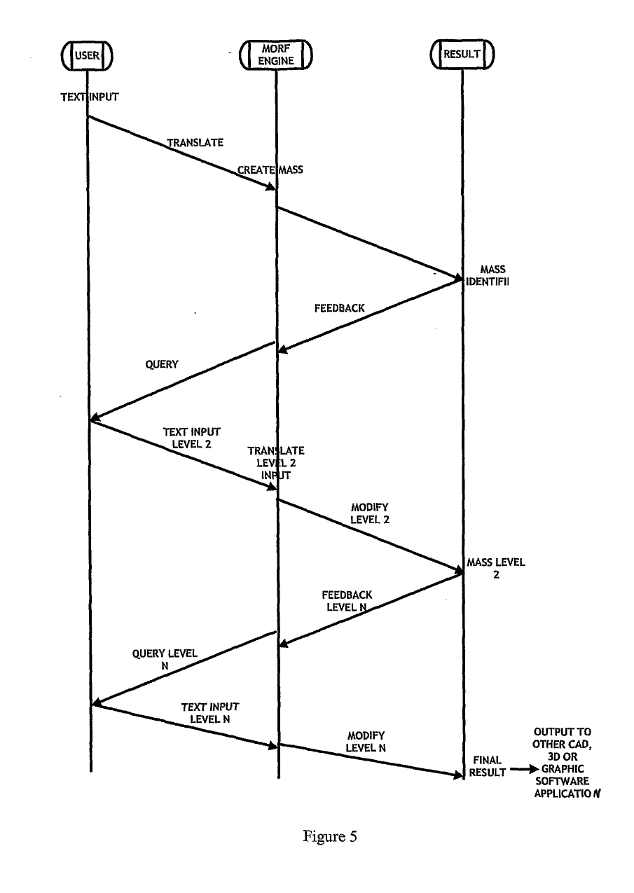

The process for creating the visual representation is iterative, as shown in FIGS. 4 and 5. Once the initial basic form is defined, then the user can input some more language, which can modify the displayed representations, using the capabilities of the heuristic engine (116). This process can be repeated many times, each time changing the representation that is being displayed. The changes are affected by the meaning of the text elements that comprise the input. These iterations are processed in the interpretive algorithm (118) to store data about the user's approach to language, and to generate artificial intelligence to “learn” about the user's language habits and to improve the results on the basis of past experience.

Generally, a user (300) initially provides text input (302 & 201) to the design heuristic engine (304). The engine (304) provides a translation or transformation function (306 & 202) to enable a text input (302) to be translated into a machine usable format via a natural language parser and its associated lexicons, grammars, etc. A dialogue controller, which possesses natural user commands and dialogue using knowledge about the domain, updates the virtual environment and adds any new knowledge elicited from the user as a response to a particular query, for example. The heuristic engine (116 & 304) then interprets the input from the user and generates a 2-dimensional or 3-dimensional transformation (308 & 203) from this input. A result (312 & 205) is then displayed to the user as a visual output.

The interpretive algorithm (118) captures feedback (314) and provides feedback images and text based queries (316 & 206) to the user (300) in order to recall, capture and refine key phrases and their definitions and descriptions of a known object or referent. Subsequent text input (318) from the user is then translated (320) by the heuristic design engine (304) to modify (322) the visual form (324) presented to the user by the 2-D or 3-D modelling and rendering engine (119). Once again, the capturing of feedback (326) and the querying (328) of the user during a number of iterations may be facilitated by the design heuristic engine (304), as are the resultant user text inputs (330) and modifications performed by the design heuristic engine (332).

The basic form for a representation is subsequently modified at step (206) and in later steps. This is done my matching at least one aspect of the visual form, to at least one meaning or aspect of the text form then entered by a user. A variety of approaches for doing this may be employed, as utilised in the field of computational linguistics.

One especially useful approach is to analyse natural language using “Discourse Representation Theory” (“DRT”) which was created by Hans Kamp in the 1980s. This can be programmed into a computer to determine the semantics of natural language, and importantly in relation to the present invention, used determine the object of a sentence (eg, that it concerns a “chair”), and the attributes of that object, (eg “comfortable”, “red”, etc) and controlling aspects (eg, move the image to the left or make it bigger). Ambiguity in language can be resolved by analysis of the syntax, or if not resolved by this means, passed back to the user for feedback and clarification. But the same method can also produce interesting and creative results with less representational language, for example “I like that” can save the current representation, “I hate that” can delete it (optionally giving the user a option to change their minds”, and “I am feeling happy today”, can have creative and less obvious results in modifying the representations.

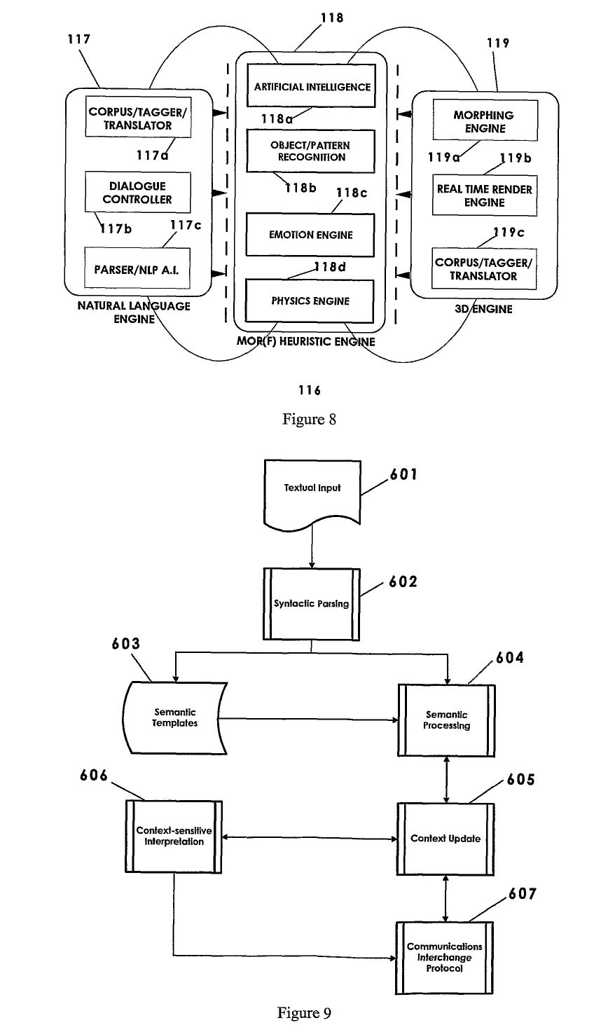

FIG. 8 shows the main heuristic engine (116) module in more detail. The three main modules comprise the natural language engine (117), the heuristic engine (118x) and the 2-D or 3-D engine (119). The natural language engine has further components the corpus/tagger translator (117a), the dialog controller (117b) and the parser/natural language processor artificial intelligence (117c) modules. The heuristic engine components (118x) combine the further components the artificial intelligence (118a), the object/pattern recognition module (118b & 121), the emotion engine (118c) and the physics engine (118d). The 2-D or 3-D engine (119) has the further components the morphing engine (119a & 120), the real time rendering engine (119b) and the corpus/tagger/translator (119c). The three modules interact with each other to create visual representations from natural language input.

The corpus/tagger translator (117a) parses the natural language, and determines its meaning from its syntax, semantics and context. The dialog controller (117b) assists in resolving ambiguities arising from the language analysis, and allows the user to develop the visual representations by answering questions posed by the system using the dialog controller. The parser/natural language processor artificial intelligence (117c) unit analyses patterns in the language input by a user, and uses the information gathered from the previous history of the user to improve the results.

The artificial intelligence (118a) unit holds and processes the domain knowledge. The object/pattern recognition module (118b & 121) allows additional and broader domain knowledge to be gathered and used in the system. The emotion engine (118c) allows the characteristics of the representations to be altered according to the emotional content of the language used. The physics engine (118d) assists with the rendering of the visual representations of the objects by keeping real-word knowledge about the object and assisting in the rendering accordingly.

The morphing engine (119a & 120) is preferably used to morph the transitions between the visual representations. The real time rendering engine (119b) creates the representations immediately after processing each set of text input. The corpus/tagger/translator (119c) tags the image and visual representation objects with their meanings, primarily about their visual and dimensional features.

The two taggers (117a) and (119c) communicate with each other, and operate to link a text element with a corresponding visual representation element. The text tagger (117a) manages the semantic and other text type information, whereas the image tagger (119c) manages the visual and structural information of an object, such as a chair, or seat, legs, arms, back, size, or colour of a chair, for instance.

The output visual representation can be any image from real objects to abstract drawings and artistic images, either as static images or animated ones. Mixtures of these different types of images may also be created.

As one relatively simple example of images that may be generated according to the present invention is the generation of “emoticons”, which in a simple form are stylised faces constructed of keyboard characters, such as “:-)” for happy or “:-(” for sad, or actual cartoons of a face, such as “ [symbol] ” or “ [symbol] ”, to more complex versions of these icons, some animated. These emoticons are often used when sending email, in internet chat rooms, or with the “Microsoft®” “Messenger™” messaging software, or with the similar software provided by “Yahoo®”, or when text or SMS messaging using a mobile telephone. Currently, the user selects an emoticon, which then is incorporated into a message to represent their emotional state, such as “happy” or “sad”. Using the current invention, the emotion can be automatically selected, according to the emotional state of the user, as determined from the meaning of the messages being sent. As a further modification, the emoticon can change, to match the current content of each part of a message that is being sent. As mentioned above, analysing meaning according to the present invention, gives better results than merely using keyword and pattern matching.

The present invention may be implemented using hardware, software or a combination thereof and may be implemented in one or more computer systems or processing systems. It may be implemented as a client/server system, or as a “thin client” system with most processing occurring centrally. It may run on computers, or in smaller devices such as mobile telephones or PDAs. It may alternatively be processed remotely on a separate system with the results transmitted to the user for display. This may involve transmission via the internet, or via other communication means, such as to a mobile telephone using the telephone connection to receive the output visual representations. The output can be stored before, or without display, as long as they are capable of display. This may occur by generating an electronic file that can directly display the visual form when a suitable software or other application is used, or may be printed for viewing directly, or may indirectly be capable of display after other or further processing of the output data such as in a CAD system.

### EXAMPLE 1

### Modifying Representations using User or Computer Defined Tags

One means by which a visual representation may be created from text elements is by using the structural properties of the various words or text elements within the natural language that was input by a user into the computer system (102). The individual words may be analysed in some way and their meanings used to affect the visual imagery being displayed. For example names of man-made objects (table, chair), natural objects (tree, bird), characters and people (John, I, you, monster), scenery (desert, waterfall, sky), emotions (like, happy, sad), descriptions (blue, big, dry) and the like, can all be identified and used to alter the visual object's appearance. The rules for doing so can be set to provide results that intensify the creativity of the design process.

One example of how to create and alter the visual object is now described. Some input text is selected. The structural properties of the text elements within this is analysed in terms of its attributes, such as codified text parameters (207) and descriptive parameters (208), as outlined in FIG. 4.

One simple approach is to have the user identify and tag various words in the text using functions provided on the computer or similar device in a number of word processing software systems, by applying different fonts, font effects such as italics, bolding, underlining, etc, font sizes, and various styles of brackets to tag the words or text elements in the document. This has an advantage of allowing the user more control of the results, although there are only a limited set of manipulations provided as a result of a finite set of formatting functions possible. A more sophisticated approach is to have the computer software tag the text elements, which is discussed in more detail below. Or a combination of computer allocation and user allocation or editing of the tags can be utilised.

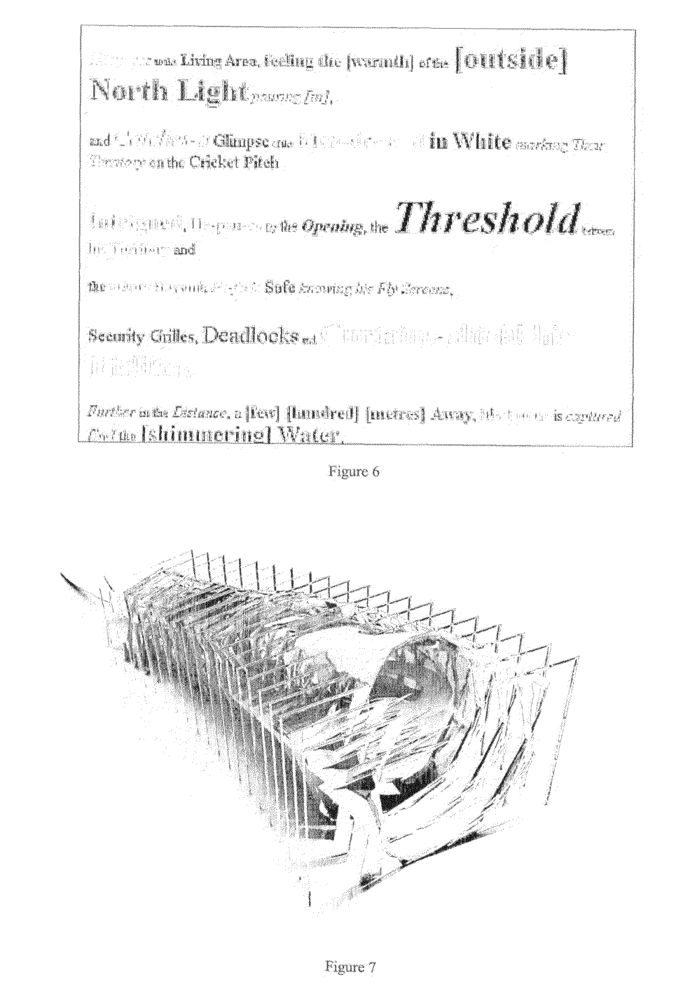

For example, FIG. 6 shows an example of a passage of text once it has been tagged or codified. The document is codified by assessing the structural properties of each word or text element in the passage. For example, the text element type, text element parameters and text element context is determined. The text element type can be any one of a Noun, Adjective, Verb, Conjunction, Prepositions, Determiner or Quantifier. The Noun text element type may also be categorised by sub-type such as “common noun”, “count noun”, “mass noun”, “proper noun”, “pronoun” or “relative noun”. Similarly the Adjective text element type may be categorised into sub-types including “possessive adjectives” and “proper adjectives”. The Verb text element type may include sub-types such as “linking verb”, “adverb” and “conjunctive adverb”.

The context of each text element defines one or more other text element structurally related to that text element. For example, one or more adjectives qualify a noun. In the context of the present invention, rather than each adjective applying a linguistic qualification to the noun, the structural properties of the adjectives structurally related to the noun act to qualify the structural properties of that noun. The parameters of each text element may include letter count (eg, word size), font style and font size. Font style may be selected from one of bold, italics or regular font style. These parameters can be used to tag the grammatical components.

Any system may be used to alter the visual object. For example, the basic visual form assigned to the initial text element input by the user at step (201) may be modified according to the font properties of that text element. In the example shown in FIG. 6, a word having a bold font acts to multiply the dimensions of the visual form displayed to the user. A variation in font size acts to vary the height of the visual form. If the text element is written in italics, the visual form displayed to the user is faceted. Moreover, the mass of the visual form is created based upon the number of letters in the word or other text element. These rules may be defined in a somewhat arbitrary manner, but the consequences of each such rule is made known to the user, so they can control the process, or understand the consequences of the tagging of the text elements in this manner.

In addition to being modified by the font properties of the text element to which the predefined basic format has been assigned, the predefined basic form is also modified according to the properties of text elements structurally related to that text element. For example, adjectives that qualify a noun to which a predefined basic form has been assigned will include structural properties that are used to further modify the visual form displayed to the user. For example, adjectives may be used to denote the materiality of a noun and word adjacent to it to generate a series of planes according to the number of letters in the adjective, especially if the representation being created is abstract. Or the mention of a “blue chair” can render the chair object in the colour blue, if the thing or object is a specific real-world one, for instance.

While a predefined basic form may be assigned to each noun in the text, the predefined basic form may equally be applied to text elements of a different text element type. For example, a basic predefined form may be applied to all verbs within the text.

Moreover, while the same predefined basic form may be assigned to each occurrence of the same text element type within a text, in other embodiments of the invention a different basic form may be applied to different occurrences of the same text element type in the text. In this way, a predefined basic form of a door may be applied to a first noun in the text, a basic predefined basic form of a cup applied to a second noun, etc.

The following example shows one form of the codification or tagging system that can be applied to a passage of text input by a user that will result in the type of codified text represented in FIG. 6.

### EXAMPLE 1A

### Tagging According to Font Features

Text Types
_-Denotes a space.
1.Nouns.
1.1 Nouns:
One word. The first character must be an uppercase letter.
Noun
Thing
Dog
1.2 Common Nouns
A noun (1.1) with ‘a’, ‘an’, ‘some’, ‘every’ or ‘my’ before it.
(a/an/some/every/my)_Noun; eg
a Space
an Apple
every Individual
1.3 Count Nouns
A noun (1.1) that end immediately with s′ or S′; eg
Places'
Books'
Drawings'
SYDNEYS' (also a Proper noun (1.5))
1.4 Mass Noun
A Noun (1.1) that has ‘/some’ in front.
/some-Noun OR/ someNoun; eg
/some Money
/some Guy
/SomeThing
/someThings' (also a Count noun (1.3))
1.5 ProperNoun
the Noun (1.1) must have all uppercase characters.
NOUN; eg
SYDNEY
JACK
1.6 Pronouns
All lowercase word surrounded by curly braces { }; eg
{my}
{they}
1.7 Reflexive pronouns
A pronoun (1.6) with ‘self’ or ‘selves’ immediately after it.
{pronoun} self or {pronoun} selves; eg
{them} selves
{my} self
2.Adjectives
2.1 Adjectives
All lowercase word surrounded by square brackets [ ], followed by a Noun (1.1).
[word]_Noun; eg
[big]Place
[long] Island
2.2 Possessive adjectives
An all lowercase word before a Noun (1.1)
word_Noun; eg
their Infrastructure
our House
2.3 Proper adjectives
An all lowercase word before a Noun (1.1).
word_Noun; eg
malaysian Food
christrian Object
3 Verbs
3.1 Verbs
Must consist of at least 2 words separated by a hyphen.
One word must be the verb (all lowercase) and the other a Noun. (1.1).
Noun-word; eg
He-runs
Sydney-moves
3.2 Linking verbs
An all lowercase word followed by either a Noun (1.1) or an adjective (not associated with 2.1). If an adjective is used then the adjective must be surrounded by [ ].
word_[adjective] OR word_Noun; eg
becoming [bigger]
seemingly [intelligent]
fearing Food
3.3 Adverbs
Consists of a Verb (3.1) followed by another an all lowercase word.

Verb_word; eg
Man-running fast
Dog-moves quickly

The foregoing codification scheme is merely one example of a scheme that may be used in conjunction with the present invention. An alternative approach is shown where text has been codified in a series of dashed lines and dots, for example.

Once the text has been codified or tagged by whatever scheme is convenient, the design heuristic engine analyses the codified text in order to determine the relevant operations to be performed to the text in order that it be transformed into a visual form for presentation to a user. The following passages describe the various modifications applied to the predefined basic form associated with the text input at step 201 according to the properties of the text element itself and text elements structurally related to that text element.

### EXAMPLE 1B

### Manipulation of Visual Form According to Text Elements Tagging

939 Nouns
1.Nouns (with capital letter): agglomerate (mass created based on a number of letters and dependent on the following characteristics:
BOLD: Multiplier of 2
Font Size (8-72) defines height
Italics: Faceted
eg House, Tree, Land, Plane etc
2.Common noun (a/an/some/every/my+noun): acts on noun; denotes direction and/or movement; highlights/wraps/glows with volumetrics around noun/
eg a Space, an Apple, some people, everv Individual, my House
3.Count noun (noun+‘s’ at the end in open inverted commas): multiples around xz axis (number of letters SQUARE—each iteration growing more transparent
eg Places, Books, Drawings
4.Mass Noun (‘some’+noun): glass and liquid inside semi-transparent ‘noun’
eg some Things (Jimmy in this case ‘things’ would refer back to count nouns because of the ‘s’ in the word ‘things’ some networks
5.Proper noun (all capitals—referring to places or people etc): no limiting modifier—generates polygon (noun) with input from students who must enter dimension for polygon based on proper name (eg Site or name of bacteria) and manipulate material and re-shape object.
eg SYDNEY, JIMMY
6.Pronoun (I, me, us, they etc. in indents.): Same as proper noun except either singular or plural (numbers generated by students)
eg<i>, <me>, <they>, <us>
7.Reflexive pronoun (pronoun+‘self’): acts on pronoun and inverts vertices
eg “big” Palace. “long” Island
Adjectives
1.Adjectives (inverted comma and word+noun eg ‘big’+noun): denotes materiality of noun and word adjacent to it; translucent sphere encasing noun+series of plane generated; number of planes denoted by a number of letters; height decided by a student (external input)
eg “big” Palace, “long” Island
2.Possessive adjective (their, his, its, our, etc—single inverted comma+noun): Crystal shards generated; forces generated by shard affects noun.
eg ‘their’ Infrastructure, ‘our’ House
3.Proper adjective (bracketed word+noun eg, “Malaysian’ food): breaks and deforms noun into blobs or globs; number of blobs determined by a number of syllables
eg (Malaysian) Food, (Christian) Object
Verbs
1.Verbs (noun+hyphenated word): all verbs will indicate movement in s, y or z or all axes; students input movement based on interpretation and this movement acts on the noun
eg He-runs; SYDNEY-moves
2.Linking verb (be, become, fear, and seem+noun/adjective)—generates links and creates autonomous primitive object(random); number of links determined by a link verb eg ‘be’=2)
eg becoming “bigger”, seemingly “intelligent”
3.Adverb (verb+bold text) or (bold text+verb): inserts frame within or without verb and generates duplications or verb and smoothes all surfaces
eg running FAST;—move QUICKLY
4.Conjunctive adverb (also, consequently, finally, furthermore, hence, however, incidentally, indeed, instead, likewise, meanwhile, nevertheless, next, nonetheless, otherwise, still, then, therefore and thus+verb) all words after conjunctive adverb till end of the sentence will combine, agglomerate and mesh together
eg Consequently, the place moves towards an agglomeration of sorts
Conjunctions
1.Conjunctions (for, and, nor, but, or, yet, so): Please refer to drawing sheet (Jimmy, talk to me about this one. I have sketches, not words)
Prepositions
1.All prepositions will be assigned either a double helix or spiral and be given a random modifier or combinations of modifiers that will affect itself and the 2 words adjacent to it. Only the following prepositions will be studied: in, at, on, to, for, since, before, in front of, on. behind, under, beneath, besides, through, of, upon, like, without, towards and off.

Determiners
1.determiners (the, a, a bit of, that, those, whatever, either): Caps nouns top and bottom
Quantifiers
1.Underlined words: multiply by a number of letters
eg one (1), two (2), three (3) four (4)

This approach (Example 1B) analyses all text as grammatical syntax (symbols) so as to generate visual representations out of an understanding of the language used, or more precisely, from the text elements present. The process interprets the text elements not so much by an understanding of basic linguistic grammar and structures, but instead by giving form to the different qualities of the syntax, words and punctuation characters present.

Following modification at step (206) of the predefined basic form by the codified text parameters (207) and descriptive parameters (208), a modified version of the visual representation is then generated at step (209) for display to a user. For example, a predefined basic form of a cylinder has been assigned to each occurrence of a noun within the text illustrated in FIG. 6. Then the position of each predefined basic form can corresponds to the position of the noun in the passage of text shown in FIG. 6. The visual representation of each predefined basic form is modified by the structural properties of the noun associated with predefined basic form as well as the structural properties of text elements structurally related to the noun. A variety of other visual forms can correspond to the textual elements that have been unable to be linked to a noun. These stray artefacts can also be used in the design process. Thus, a user is able to manipulate the visual forms that display.

As another example, an adverb, eg, “frantic” taken from the text passage, can be tagged to have a font size of 6 and in a bold font style. The word “frantic” acts in this case as an adverb by qualifying the word “sound”. However, if we desire, the literal meaning of “frantic” need have no importance. Rather, the structural properties of its word length, font style and size are associated with predefined modifications of an existing visual representation of an object.

Following the user manipulation at step (210), and the modification of the codified text parameters and descriptive parameters of the text elements within the text, the visual form represented to the user is once again modified at step (211) and displayed to the user at step (212).

It is possible for a user to manipulate the visual form itself. For instance, two distorted columns (as an example) may be represented to the observer. The design heuristic engine (116) can allow a user to select these objects and subsequently rotate or otherwise manipulate them, from the text element in the user's input. So, these two objects can be rotated by 90 degrees, and then other modifications applied subsequently.

FIG. 7 provides an example of a final visual form at the conclusion of the design process, once the basic predefined form assigned to a textual element has been modified by the properties of the text element with which it is associated and the text elements structurally relating to that text element, and by a series of user manipulations. While this image is not very representational, other representational images such as trees or the like, can be generated instead in a like manner. However, this image has been modified from an initial simple design to the complex one shown in FIG. 7 by entering text to cause elements of the image to rotate, be copied, and otherwise to expand the various drawing elements, to eventually arrive at the image shown, just by the input of language in a text form.

It can be seen that this process can generate a variety of unique images and representations. This example uses a method that may be usefully applied to an educational software package or a game for children, for example, or as a training system for users to accustom them to more advanced approaches.

However, it would be more useful to apply this general process without the need to display the tagging of the text elements, to the user.

### EXAMPLE 2

### Natural Language Parser to Fully Understand Context in Linguistic Input (Text & Speech)

Another process from natural language to visualizing the subject content and context contained a linguistic input in any iteration is described below:

This section describes some algorithms used for a contextual-based natural language parser as a very useful component of the heuristic engine (116).

The approach for understanding natural language and creating an image associated with the meaning of the language are generally known. For example a common approach uses Discourse Representation Theory (DRT), as mentioned previously, and one method of utilising the Theory is described in “Discourse Representation Theory an Updated Survey” by Agnes Bende-Farkas, Hans Kemp, and Josef van Genabith, ESSLII 2003 Vienna, published 3 Sep. 2003, which is incorporated in this specification by cross-reference.

### EXAMPLE 2A

### Natural Language Parser (“NLP”) Engine

The NLP Engine of this example is differentiated from the previous prior-art NLP-type engines is the mechanism of context update. This uses and understanding of context, content and concept in language to interpret the meaning of the language that is being input. This understanding drives the interpretation of the language and updates and informs the process so that the results are more accurate than previously known approaches. Previous such approaches relied on a simple one to many semantic mapping (eg, does “turkey” mean a country, or a bird, or a poor design?). In this invention, the inherent ambiguity and dis-ambiguity in natural language can often be resolved by applying some semantic analysis such as DRT analysis to model the context of any ambiguity, and hopefully resolve it. The results of this analysis can also assist with obtaining feedback from the user to resolve any remaining issues with interpreting the language. This has the result of producing more accurate 2- and 3-dimensional representations. The interpretation process entails the construction of Communications Interchange Protocol (“CIP”) transformations that then can modify or affect the visual forms that are generated by the system.

### Contextual Model

The system of context and context update carried out in the heuristic engine (116) acts as a hub for efficient or intellegent processing. In the intelligent processing of linguistic descriptions the model of context operates in a dynamic purpose-driven fashion. The automatic determination of purpose and intention in design is the crux of the language processing component. Automated learning of design principals, user behaviours and profiles emerges from a model of context update.

Actions are the basis of any design decision and embody a transfer from cause to effect. In order to efficiently process free-text or natural language, knowledge of the general manner of the design to be created (ie, the design domain) and basic common-sense type information is required. That is, in order to infer a user's design intention and to aid in this process, the system should have a basic working knowledge of design and a working memory of what has been created thus far.

The transference from working memory to effect is based upon a cause that is acquired from the linguistic description. The most influential class of linguistic information that provides a clue as to the type of causal action that is being construed are verbs. By considering verb classes it is possible to treat the problem of language understanding or interpretation as a template-filling exercise. By filling values in a template the system is able to construct features in order to learn generalisation rules. Another advantage that comes from the deployment of such an approach is in the automated construction of templates themselves. That is, templates can also be constructed dynamically by the system. The set of possible actions or design paradigms is not fixed, they can mutate and grow dynamically.

Then it is necessary to determine how templates are initially constructed, how the templates are filled, and to determine the mechanisms that allow automatic template construction and development.

### Templates

A number of seed templates are constructed in order to bootstrap the contextual representation. The following templates and their associated constituent roles comprise an example of those that may initially be made available to the system. These templates all can be seen to allow an image displayed on a screen to be manipulated.
Add: add Object1 to Object2 at Position.
Remove: remove Object1 from Object2.
Commotion: commotion Object
Divide: divide Object in Manner.
Enlarge: enlarge Object by Amount.
Horizontal: horizontal X-Directions.
Move: move Object to Destination Somehow.
Reduce: reduce Object by Amount.
Replace: replace Object1 with Object2.
Rotate: rotate Object in Direction by Amount.
Unite: unite Object1 with Object2.
Vertical: vertical Y-Directions.

### Template Filling

If the computation of linguistic forms is based upon the main verb in the sentence then the selection, and possibly, the creation of the template to be filled is also conditioned upon the main verb.

This is based upon the notion of determining classes of verbs that have similar semantic properties and in some cases, similar syntactic properties. In other words, verbs in a language are divided into one or more classes which represent a general common meaning, and synonyms and different verbs that have a related meaning are grouped together in one class. Each word is mapped to a number of such classes, and preferably the closeness of each word to the other words in the class may be measured with a numeric “closeness” value, so the accuracy of a match can be scaled and compared to alternative meanings. The selection of the classes depends on the results desired, and relate to the image manipulation result wanted. For instance, “delete, cancel, throw away, hate, discard, kill” can constitute one class of verbs that result in the image being discarded. This approach also takes into account negatives. The formal description of such behaviour is referred to as “verb class alternation”. Classes of verbs are constructed where member predicates with similar semantics demonstrate similarities in their syntactic configuration.

Once the main verb in the sentence is known it is assigned to one of a number of verb classes. Each verb class is modified to some extent by the syntax of the sentence, that is, by the words located around it and structurally related to it, so that the default meaning is changed accordingly, and overwritten.

This implies that each verb class generates or governs its own template-filling procedures. The verb is firstly classified into its respective class. The corresponding procedures or agents are then set into action. These procedures may act as strict functions that operate on the syntactic parse, or they may operate under a “daemon model” where they lay in waiting until an appropriate event is triggered. The “daemon model” is an approach whereby the operation is only activated when the user enters some instruction; it otherwise lays idle until this occurs.

The Semantics class in the NLP Engine contains methods such as the following that apply to a particular syntactic structure. The following example utilise the “Python” language which is referred to in the “Bende-Farkas” publication, mentioned previously.
getSentenceHead(sentence)
loadTemplate(sentenceHead)
handleRoles(semanticClass)

### Context Update

The Context class is designed to model items that are introduced via textual descriptions. The class keeps track of the current Object Under Discussion (“OUD”), otherwise known as the most salient object. The OUD is most likely to be resolved as the referent of an anaphoric reference, or in other words, identifying a pattern where the word refers back to a word used earlier in the passage, eg, “do” in “I like it and so do they”.

The Semantics class operates directly using the Context class. Semantics accepts Syntax (a syntactic tree structure) as a parameter and modulates the Context based on its interpretation of each constituent in the syntactic structure. The template-filling approach is employed by the Semantics class. When an appropriate argument is encountered the Semantics class updates Context by first loading a semantic template into Context. Examples of syntactic structures that are addressed by the system are active and passive sentences. An example of a passive sentence is “The chair's legs should be longer”:

```
(S
  (NP
  (NP (DT the) (NN chair) (POS 's))
  (NNS legs))
  (VP (MD should)
  (VP (VB be)
    (ADJP (JJR longer)))))
```

An example of an active sentence is “Make the chair's legs longer:”

```
(S
  (VP (VB Make)
  (NP
    (NP (DT the) (NN chair) (POS 's))
    (NNS legs))
  (ADVP (RBR longer))))
```

The major discriminating factor between actives and passives is the position of the verb in relation to the subject. In the case of the passive, the verb usually follows the “chair” subject whilst in the case of actives the situation is reversed.

The detection of active or passive sentence type has consequences for semantic intrepretation. The operation of semantic interpretation relies on the correct integration of arguments into semantic templates. That is, the head (verb) of the sentence is assigned to its corresponding template class, each template contains a default value structure, and the syntactic arguments are semantically intepreted in order to ‘fill’ the template by overriding default values where necessary.

### Artificial Object Generation

The following description provides an overview of the context model approach to object generation by way of example. The example demonstrates the construction of a chair and the manipulation of the chair by swapping its seat. The following discourse provides the basis for which the transformations in visual space are generated.

(1) “I would like to design a new camp chair.”

(2) “May I replace the seat with an Eames chair seat please.”

The context begins with no objects in the world. The input is syntactically parsed and each constituent in the tree structure is sent to Semantics for contextual interpretation. The parse and process involved in the interpretation of the first sentence is illustrated below.

```
(S
  (NP (PRP I))
  (VP (MD would)
  (VP (VB like)
    (S
    (VP (TO to)
      (VP (VB design)
      (NP (DT a) (JJ new) (NN camp) (NN chair)))))))))
```

The following step in the interpretation process entails the detection of the sentence head and the association of a template type. In this case, two potential candidates are discovered, like and design. The latter candidate (design) is selected and associated with the Add template.

Add: add Object1 to Object2 at Position.

Once the template is acquired the corresponding roles are loaded into Context in preparation for update. The roles that are loaded in this instance are Object1, Object2, and Position.

The following step involves contextual interpretation of each constituent in an attempt to fill each of the roles currently loaded. The following fragment illustrates the process:
Semantics::VP design
   getHead:: (VB: ‘design’)
Semantics::NP camp chair
   getHead:: (NN: ‘camp chair’)
   found object::camp chair

A “camp chair” object is found and loaded into the appropriate role in Context. In this case only a single role is loaded. On sentence completion the Context object is interpreted in order to construct a Communications Interchange Protocol (CIP) transformation. The transformation that is produced and the resulting visualisation are presented below. This example used the “XML” standard to flag the transformation, but other approaches may be used instead.

<action type=“add” id=“id-chair”>
<part id=“id-back”
path=“M:\3D_Repository\camp_chair +2841609 \back \back.3ds”/>
<part id=“id-legs”
path=“M:\3D_Repository\camp_chair+2841609\legs\legs.3ds”/>
<part id=“id-seat”
path=“M:\3D_Repository\camp_chair+2841609\seat\seat.3ds”/>
</action>

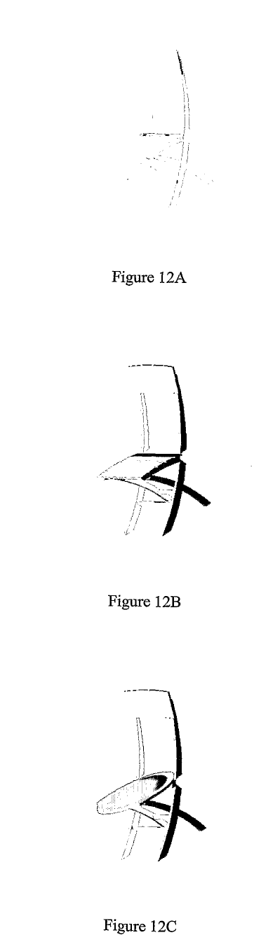

The desired object as a visual representation appears by morphing onto the screen. The first image In FIG. 12A displays the object as it begins to morph onto screen and the second image, in FIG. 12B displays the final form. The representation shown as FIG. 12C shows the chair once the seat has been changed to an “Eames” type of seat, as described in the following passage.

Interpretation of the second sentence (2) follows similar processing steps. The exception is the use of contextual knowledge that has been introduced in previous discourse. A parse of the sentence is produced and presented below.

```
(SQ (VBD May)
  (NP (PRP I))
  (VP (VB replace)
  (NP (DT the) (NN seat))
  (PP (IN with)
    (NP (DT an) (NNP Eames) (NN chair) (NN seat) (NN please)))))
```

Given the presence of a seat object in context the system is able to resolve the reference as pointing to the seat from the camp chair that has previously been introduced. A Replace template is triggered through identification of the sentence head and corresponding roles triggered. The following template and roles are loaded into Context:

Replace: replace Object1 with Object2.

Each constituent in the syntactic parse tree is interpreted and loaded into the appropriate role. Upon completion Context is translated into the following CIP XML transformation:

<action id=“id-capt_chair” type=“add”>
<part id=“id-back”
path=“M:\3D_Repository\ captain's_chair+2852743\back\back.3ds”/>
<part id=“id-legs”
path=“M:\3D_Repository\ captain's_chair+2852743\legs\legs.3ds”/>
<part id=“id-seat”
path=“M:\3D_Repository\ captain's_chair+2852743\seat\seat.3ds”/>
</action>

The resulting visual form, in FIG. 12C, has the seat replaced by an Eames chair seat.

This approach is shown in the flowchart of FIG. 9. The text form input (601) is processed in the syntactic parsing module (602) which analyses the syntax of the language. Then the semantic processor (604) and the semantic templates (605) analyse the sematic meaning of the language, and interact with each other doing so. The analysis to determine the meaning of the language used occurs by the considering the context, using the content update module (605) and the context sensitive interpretation (606) units. The data is then passed by the Communication Interchange Protocol (CIP) (607), to be processed further to create a visual representation based on the meaning of the text elements that this process has identified.

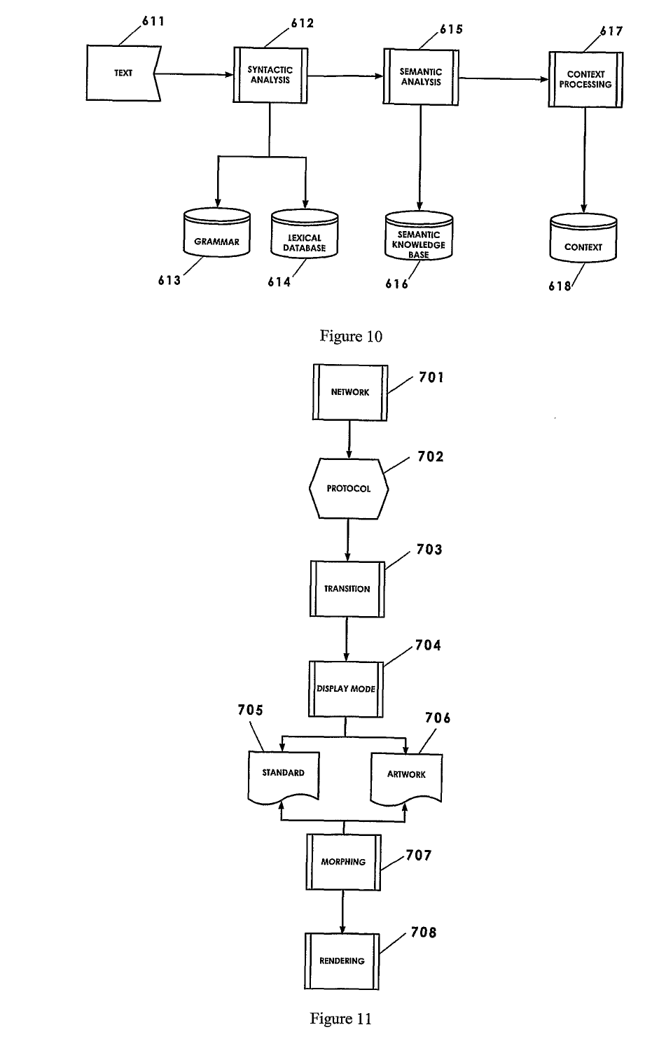

The meaning of the natural language is determined using semantic analysis and preferable also syntactic analysis and/or also context analysis, which particularly assists with handling any ambiguity in the language. This is also shown in FIG. 10, where the the text (611) is shown as being processed by the syntactic analysis module (612), which accesses a grammar (613) and lexical (614) database. The text is also subjected to semantic analysis (615) with the use of a semantic knowledge base (616), and also context processing (617) with the use of a context database (618). While all three analyses is preferred, the semantic analysis is the most advantageous to use, and the use also of the syntactic and/or context analysis is preferred, but may be omitted in some circumstances.

### EXAMPLE 3

### Emotional Visualisation

It is also a useful feature of the present invention, to utilise emotional attributes of natural language. This is a new approach, and it generates more creative and innovative images. Humans are hardwired to use emotion laden words, and identifying and carrying out transformations based on such language can give improved results.

Translation of textual form into emotional-based artistic forms is based on the interpretation of text into a set of emotional categories. A combination of one or more of the categories listed in the table below are used as input into the 3-D artwork system.
Anger
Contentment
Discontent
Envy
Excitement
Fear
Joy
Loneliness
Love
Optimism
Peacefulness
Romantic love
Sadness
Shame
Surprise
Worry

These categories are only one example of the emotional categories that can be selected and utilised. Other categories, and numbers of categories may be used with the invention. Creating more categories can give more options, and more complex results. A small number of categories may be used in some circumstances, such as to generate simple images on the small screen for a mobile telephone, for instance.

Examples of visualisations that are generated through Communications Interchange Protocol (CIP) transformations transmitted to the 3-D artwork visualisation system as a result of interpretation of textual forms are presented below. The example provided here are representations produced by one of the artforms incorporated into the system called “MondrianLines” that can produce Mondrian style artforms. The three examples presented below reflect representations of the joy, sadness, and fear emotion categories. Other approaches can be used to generate abstract or aesthetic images and representations; the Mondrian artform is used here merely as an example.

Here is an example of some input language:

“It had been years since I had seen my youngest brother. I was overjoyed to finally see his face in person once again.”

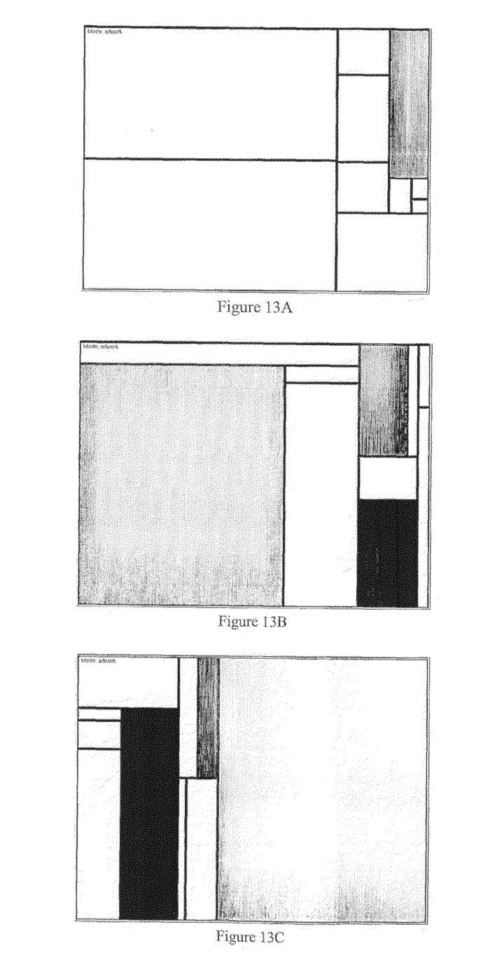

The CIP XML transformation generated through detection of the joy category of emotion is displayed below and the visual representation that is produced as a result is shown as FIG. 13A.

<action type=“artwork-mondrianLines” id=“artwork”>
<params divisions=“10”/>
<colour number=“1” red=“1.0” green=“1.0” blue=“0.0” alpha=“1.0”/>
<colour number=“1” red=“0.0” green=“1.0” blue=“0.0” alpha=“1.0”/>
<colour number=“1” red=“1.0” green=“0.647” blue=“0.0” alpha=“1.0”/>
</action>

The results with the following language example are given in FIG. 13B.

“I was living in extremely lavish comfort until the depression came. It was an unbelievably miserable period of time.”

The CIP transformation generated through detection of the sadness category of emotion is displayed below followed by the visual representation that is produced as a result.

<action type=“artwork-mondrianLines” id=“artwork”>
<params divisions=“10”/>
<colour number=“1” red=“0.6” green=“0.6” blue=“0.6” alpha=“1.0”/>
<colour number=“1” red=“0.0” green=“0.0” blue=“0.0” alpha=“1.0”/>
<colour number=“1” red=“0.647” green=“0.165” blue=“0.165”
alpha=“1.0”/>
</action>

The results with the following language example is shown as FIG. 13C. “The film was one of the scariest I had ever seen. Never before had I been afraid to go to sleep.”

The CIP XML transformation generated through detection of the fear category of emotion is displayed below followed by the visual representation that is produced as a result.

<action type=“artwork-mondrianLines” id=“artwork”>
<params divisions=“10”/>
<colour number=“1” red=“1.0” green=“0.0” blue=“0.0” alpha=“1.0”/>
<colour number=“1” red=“0.0” green=“0.0” blue=“0.0” alpha=“1.0”/>
<colour number=“1” red=“0.0” green=“0.0” blue=“1.0” alpha=“1.0”/>
</action>

The images generated are somewhat subjective as a value judgement must be taken as to the appearance of artwork that represents emotions, such as happy or sad. However, art critics can perceive the emotional content of work of art, and it is generally believed or conjectured that humans have a universal ability to perceive an emotional aspect for abstract art, however subtle. Simple feedback experiments may be used with a number of test subjects to gather statistical information on the emotional affect of any abstract imagery, which can then be used to allocate an aspect of imagery with classes of words that have an emotional connection. As one approach, all words may be allocated to each class, along with a measure of or numeric value for the applicability of the word for that emotion.

### General

The above described computer assisted design system describes an interactive design heuristic engine that relies on an intelligent real-time learning algorithm that assists and enhances the design and visualisation process. The heuristic engine, through a process of analysis, understanding, interpretation, querying and feedback has the ability to translate text and language, through various input devices such as typing, voice recognition, optical character recognition and pattern recognition etc., and transforms it into a visual form. The design and visualisation process is not only unpredictable, but it also involves a synthesis of descriptive, imaginative, creative, emotional and pragmatic issues. This engine starts out by eliciting a subject and objective in the design process (e.g. visualizing and designing a chair) and then through a process of refining, defining and querying, is able to transform the described and prescribed elements of the objective into a series of possible design and visualisation outcomes.

As the objective is further refined and archetypal principles articulated, the engine adapts to such changes and the end results becomes more sophisticated. The engine then creates a number of possible design propositions that the user can choose from, to further expand into other applications.

The heuristic design engine (116) shown in FIG. 2 and FIG. 3 includes but is not exclusive to the practical implementation of the components of a natural language interface into a Virtual E-nviroument (VE), including the requirements of natural language understanding, spatial domain knowledge and reasoning capabilities, and human-to-computer interaction. In order to fully understand the full static and dynamic range of linguistic knowledge, the heuristic design engine (116) provides a model for the storage and representation of spatial knowledge, as well as facilitating various methods for applying linguistic knowledge to this domain. A grammar designed to fit the requirements of the natural language interface is constructed and an encoding in XML or UML as well as C++ coding may then be applied for any such grammar. The design heuristic engine (116) also provides an advanced parser to implement and apply the grammar and syntax and its understood context to a 2-dimensional or 3-dimensional converter with a natural language processor and interface attached.

The natural language processor (NLP) and interface (NLI) forms part of the linguistic cognitive base algorithm (117) and uses a subset of “natural” language, namely language that is used in everyday conversation. The invention utilises a parser that can understand and analyse the components and that spans an entire language by building up complex root and derivative structures in language within a linguistic repository.

One major difficulty with interfaces to VE systems is the fact that the user's hands and eyes are occupied in a virtual world, so that standard input devices such as mice and keyboards, physical supports and/or visual attention are impractical in some instances and may require specialised skill and high-end knowledge to operate such systems. Language, however, is ideally suited to abstract manipulations especially in articulating ideas. It is also the most natural form of communication for humans, and does not require the use of one's hand or eyes. For this reason, the oral input via the microphones (108) and voice input device (109) to the text input device (103) is in many instances a very useful means for providing natural language input to the design heuristic engine (116).

The design heuristic engine (116) acts as a bridge or translator to translate the natural language input to the natural language interface into actual actions within the domain. In a virtual environment, the design heuristic engine has the ability to store, derive, translate and verify spatial relations within the domain and to convert these to a format usable by the system (100).

Although in the above described embodiment of the invention, the virtual environment in which the design is created is then supplied to a CAD engine (134 & 135), in other embodiments of the invention the virtual environment may be converted into results suitable for use by a variety of applications (as exemplified by the applications (136) to (140) shown in FIG. 3).

Aside from being able to understand descriptions of archetypes for the design of 2-D or 3-D objects in a domain, the design heuristic engine (116) not only understands and translates the text input from a user but can also translate orientation within a 2-D or 3-D domain such as “Above”, “left”, “front”, etc. as well as emotional content such as “joy”, “love”, “anger”, “depression”, etc.

### EXAMPLE 4

### 2-D and 3-D Visual Representation Creation

Once the meaning of text elements has been determined, the heuristic engine (116) creates a visual representation, associated with the meaning.

As shown in FIGS. 3 and 11, the data that has been created from the natural language input, and which has been processed in the heuristic engine (116) is passed to the text form builder and renderer (143), or in other words, the 2- and 3-D rendering engine (119), in FIG. 8.

The object is usually made up of its constituent components, for example a chair may be constructed of legs, seat, arms and a back. The rendering engine (119b) draws a visual image of the object on a screen, in real time, ensuring all the constituent part as correctly displayed, so that the parts of a chair are assembled in the right way to function as a chair.

When the object is altered as a result of the additional language input provided by a user, then the image may change to a variation of the previous image. This can be an abrupt transition, whereby the second image replaces the first one immediately or after a short period, or else, and preferably, the image can metamorphose from one to the other in a slow and seamless manner. This may be done by the morphing engine (119a) in FIG. 8 or the morphing module (120) in FIG. 2.

Metamorphosing or “morphing” involves changing one image into another through a seamless transition. Computer software can create realistic-looking transitions by finding corresponding points between the two images and distorting one into the other as they cross fade. The morphing effect is to help make the transitions of objects onto and off the screen appear smoother and more organic to the user. The morphing effect provides the user with a more visually appealing view than a window that is completely blank before showing an altered image, or by showing an immediate but discontinuous transformation.

The 2-D or 3-D modelling and rendering engine (119) in FIG. 2 may use CAD techniques to render the visual representation on a computer screen or in some other media. However, in place of the user having to manipulate the image creation directly using the CAD drawing and management tools, in the present invention, this is managed, and least in part, by the software system, and heuristic engine (116). The user may also assist with the process, or manually modify the output, if desired, as shown by (113) in FIG. 3.

In FIG. 11, the heuristic engine (701) passes data to the CIP (702). Transition controls such as “display”, “swap” or “modify”, are then recognised in component (703), and create, replace of update the current representation. The user may then select a display mode (704) to produce either an objective representation (705) or an abstract and artistic representation (706). The transitions between successive images may be handled by morphing using the morphing component (707). Finally the rendering unit (708) displays the visual representation.

### EXAMPLE 5

### Emoticons

As a further relatively simple example the system may be used to render an emoticon, which can be a simple “smiley face” or a more advanced face of a person, rendered in some detail and made to look realistic.

The face emoticon can be preferably programmed to have a number of “muscle” vertices that change the facial features so that the face appears to be smiling, frowning, sad, crying, or angry for example. Alternatively, larger expressions involving more of the face or torso can be used to indicate agreement and satisfaction by nodding “yes” or dissatisfaction or negation by shaking the head from side to side, for example.

For example, the face can be programmed to change into any one of a defined set of emotional attributes, For instance, these attributes may represent:—Anger, Contentment, Discontent, Envy, Excitement, Fear, Joy, Loneliness, Love, Optimism, Peacefulness, Romantic love, Sadness, Shame, Surprise, Worry. Fewer or more attributes may be selected, but this list will allow for realistic responses to be displayed according to the meaning of the communication.

The system of the present invention can control the emoticon face, and operate with any text input, to analyse the emotional content for the language, and as a consequence, to render the face to match the emotion of the text content.

These emoticons may be applied in internet chat-room communication, without requiring the user to select emoticons to match the mood or content of the message to change the emoticon image manually. The emoticon can instead change seamlessly using the system of the present invention.

It will be apparent that obvious variations or modifications may be made in accordance with the spirit of the invention that are intended to be part of the invention, and any such obvious variations or modification are therefore within the scope of the invention.

1. A method for transforming data utilising an electronic device, from a substantially natural language text form into a visual form that is capable of being shown on a display unit of an electronic device as a 2- or 3-dimensional visual representation; comprising the steps of;
(a) a user inputting the data into the device; and if not already in the text form, having the device convert it into the text form;
(b) processing the text form in the device to transform it into the visual form;
(c) a user inputting more of the data into the device, and if necessary converting it into more of the text form;
(d) processing the text form from step (c) in the device to modify the visual form to an adapted visual form;
(e) if desired, repeating steps (c) and (d) one or more times; characterised in that said processing is carried out by dynamically: analysing said text form, determining at least one meaning for at least a substantial portion of said text form, determining at least one visual representation that corresponds with said meaning, and creating or modifying a visual form to accord with said visual representation.

2. The method of claim 1, wherein the text form is one or more words in natural language.

3. The method of claim 1, wherein the data in steps (a) or (c) is initially in the form of spoken language, and is transformed using voice recognition techniques into a text form.

4. The method of claim 1, wherein said meaning is determined by applying semantic, morphological and/or syntactical principles to said text form.

5. The method of claim 1, wherein in step (b) or (d), if the meaning of the text form cannot be sufficiently determined in order to determine a visual form for its transformation, then a further step is conducted, of preparing and requesting and optionally receiving further input from the user, one or more times, until the meaning can be sufficiently determined.

6. The method of claim 5, wherein the preparing and requesting and then optionally receiving further information comprises displaying a question in natural language, to the user, and then allowing the user the option of responding to the question, by inputting additional data into the device, which is further processed in step (b) or (d).

7. The method of claim 1, wherein said meaning is determined by the steps of:
(i) separating said text form into a plurality of text elements, each consisting of individual words, or segments of text comprising multiple words; and
(ii) tagging each text element according to its semantic, morphological, and/or syntactical purpose to provide a plurality of sets of tagged text elements; and
(iii) whereby the tagging permits at least some understanding of the meaning of the text form.

8. The method of claim 7, wherein said tagging of each text element is for the purpose of any one or more of:—determining a text element that represents a thing and then displaying a visual representation of the thing, determining a text element that represent an action and then displaying a representation that visually embodies or utilises the action, determining a text element that represents an attribute of the thing or the action and then displaying a visual representation that visually embodies or utilises the attribute.

9. The method of claim 8, wherein the attribute of the thing or action is an emotional attribute.

10. The method of claim 9, wherein the emotional attributes are any one or more of the following classes: Anger, Contentment, Discontent, Envy, Excitement, Fear, Joy, Loneliness, Love, Optimism, Peacefulness, Romantic love, Sadness, Shame, Surprise, Worry.

11. The method of claim 1, wherein the text form is analysed by mapping it to one from a selection of predetermined templates.

12. The method of claim 7, wherein the text element is determined to comprise instructions for manipulating the appearance of the visual form.

13. The method of claim 12, wherein said instructions allow for the creation, deletion, movement, or interrelation of said visual form, or of components of said visual form.

14. The method of claim 1, wherein said visual representation is determined by analysing the visual characteristics of a plurality of visual representations, wherein each of said characteristics have one or more representative meanings allocated to them, and carrying out a best fit determination to select one or more visual representations that most closely match the meaning determined from the text form.

15. The method of claim 1, wherein initially, a basic visual form is selected that is subsequently manipulated in steps (c), (d) and (e).

16. The method of claim 15, wherein the basic visual form is chosen from a group of visual forms by the device obtaining input data from a user one or more times to limit the visual forms until one form is selected.

17. The method of claim 15, wherein the basic visual form is obtained as input from a user as a visual form, and subsequently manipulated in steps (c), (d) and (e).

18. The method of claim 14, wherein said visual characteristics comprise features of descriptive appearance, including the size, shape, location, configuration, colours, 3-dimensional orientation, background, appearance of movement, of the visual representation.

19. The method of claim 14, wherein the visual form is created or adapted by applying domain knowledge about the visual form to said visual representation, and adapting the visual form in accordance with the domain knowledge.

20. The method of claim 1, wherein the device stores the history of each user's utilisation of the method, and utilises this history in one or more steps.

21. The method of claim 1 wherein the visual form changes to the adapted visual form by morphing between the forms.

22. The method of any one of claims 1, wherein in step (b) or (d), a user additionally makes a choice to create either a visual form representing a thing that exists in the world or a visual form representing an abstract or non-representative image that does not exist in the real world.

23. A device that carries out a method for transforming data from a substantially natural language text form into a visual form to be shown on a display unit as a multidimensional visual representation, wherein said method comprises the steps of:
(a) receiving the data, and if the data is not already in the text form, converting the data into the text form;
(b) processing the text form to transform the text form into the visual form;
(c) receiving additional data, and if necessary converting the additional data into more of the text form;
(d) processing the text form from step (c) to modify the visual form to an adapted visual form; and
(e) if desired, repeating steps (c) and (d); wherein the processing of steps (c) and (d) is carried out by dynamically: analysing said text form, determining at least one meaning for at least a substantial portion of said text form, determining at least one visual representation that corresponds with said meaning, and creating or modifying a visual form to accord with said visual representation, and
wherein said device includes:
(1) an input that accepts data input in a form selected from the group consisting of text, and a form convertible into text;
(2) a natural language processor that analyzes natural language and determines a meaning of text elements that comprise the natural language;
(3) a multidimensional modelling and rendering processor that creates a visual representation associated with the text elements of (2);
(4) an output for visually-representable data that performs a function selected from the group consisting of displaying the visually-representable data, holding the visually-representable data, and transferring the visually-representable data; and
(5) a user interface.

24. The device of claim 23, which further includes:—
(7) a heuristic processor sub-system/engine that holds the history of a user's interaction with the natural language processor, and utilises the history in determining the meaning in (2).

25. The device of claim 24 which further includes:
(8) a object or pattern recognition processor sub-system/engine as part of (7) that assists with the mapping of a text element to a visual representation.

26. The device of claim 25, wherein the object or pattern recognition processor subsystem/engine updates the domain knowledge for the visual representations available in the system.

27. The device of claim 23, which further includes:
(9) a morphing processor sub-system/engine as part of (3) that renders and morphs the visual representation during transitions from one visual representation to a modified visual representation.

28. The device of claim 23, wherein the device is selected from the group consisting of a computer, a PDA, and a mobile telephone.

29. (canceled)
